(19) United States
(12) Patent Application Publication
(10) Pub. No.: US 2017/0117603 A1
(43) Pub. Date: Apr. 27, 2017

(54) VERY HIGH VOLTAGE COAXIAL CABLE DESIGN FOR MATCHING SYSTEM IMPEDANCE WITH MINIMAL CABLE CROSS SECTION

(71) Applicant: Pulse Biosciences, Inc., Burlingame, CA (US)

(72) Inventors: Mark P. Kreis, San Francisco, CA (US); Brian G. Athos, San Francisco, CA (US)

(73) Assignee: Pulse Biosciences, Inc., Burlingame, CA (US)

(21) Appl. No.: 15/331,512

(22) Filed: Oct. 21, 2016

Related U.S. Application Data
(60) Provisional application No. 62/244,575, filed on Oct. 21, 2015.

(51) Int. Cl. H01P 3/06; H01B 7/00; H01P 11/00; H01B 3/46; H01B 3/42; H01B 7/18; H01B 3/30

(52) U.S. Cl. CPC H01P 3/06; H01B 7/18; H01B 7/0009; H01B 3/305; H01B 3/46; H01B 3/427; H01P 11/005

(57) ABSTRACT

A high-voltage coaxial cable with a hollow inner conductor is described. The hollow region can be filled with a non-conducting filler. The inner conductor is surrounded by a dielectric, which is surrounded by an outer conductor and jacket. Methods and systems for designing these very high voltage coaxial cables with matching system impedance and minimal cable cross sections are provided. Embodiments include coaxial cables, systems, and methods for designing coaxial cables with high standoff voltage capacity, greater flexibility than standard coaxial cable, and a given impedance. Embodiments provide setting the requirements for an insulator of a coaxial cable driving the dimensions of the other components of the coaxial cable.

### CROSS-REFERENCE TO RELATED APPLICATIONS

This application claims the benefit of U.S. Provisional Patent Application No. 62/244,575, filed Oct. 21, 2015, and titled “VERY HIGH VOLTAGE COAXIAL CABLE DESIGN FOR MATCHING SYSTEM IMPEDANCE WITH MINIMAL CABLE CROSS SECTION.” The entire disclose of that application is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by referenced under 37 CFR 1.57.

### FIELD

The disclosure generally relates to the design of coaxial cables. Specifically, the disclosure relates to the creation of high voltage coaxial cables for a given insulation material, voltage standoff, and impedance value.

### BACKGROUND

Standard coaxial cables are often designed for relatively high impedances with low-voltage applications in mind. Since the characteristic impedance of a coaxial cable is a function of the dielectric constant of the inner insulator and the radii of the inner and outer conductors, designing coaxial cables for high impedances can necessitate certain dimensions for the coaxial cable which may be undesirable for high voltage applications. For example, using the standard formulas to calculate the dimensions of a coaxial cable can result in a cable which has a large diameter, is very stiff, and has too low a voltage capacity. In most standard coaxial cables, designing for high voltage is not a concern or objective.

Embodiments of the invention address these and other problems, individually and collectively.

### BRIEF SUMMARY

Generally, high voltage coaxial cables having a hollow inner conductor are described. The hollowed portion can be filled with a nonconducting filler. During design, given a certain standoff distance between the inner conductor and outer conductor for high voltages, the difference in the diameters of the inner conductor and outer conductor are sized for a particular impedance. At high voltages and impedances of interest, this can result in relatively large diameters for inner conductors. Therefore, the inner conductor is hollowed out and filled with a filler. This application discloses these coaxial cables, and systems and methods for designing coaxial cables, with high standoff voltage capacity for a given impedance and greater flexibility than standard coaxial cables.

In some embodiments, various aspects of the insulator of the coaxial cable serve as a primary constraint of the design of the coaxial cable. In some embodiments, the desired standoff voltage capacity may also be taken into account as it is dependent on various aspects of the insulator. For example, the chosen material or structure of the insulator may change the dielectric constant of the insulator, which affects the standoff voltage capacity. As another example, the thickness of the insulator may also affect the standoff voltage capacity, which can be increased by increasing the insulator thickness. Setting the requirements for an insulator of a coaxial cable first before determining the dimensions of the other components of a coaxial cable can ensure a particular standoff voltage capacity and makes the cable well-suited for high-voltage applications.

Other embodiments are directed to systems, portable consumer devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 is a diagram of a manufactured coaxial cable according to embodiments of the present invention.

FIG. 2 is a diagram of an unwrapped cross-section of a coaxial cable according to embodiments of the present invention.

FIG. 3 is a diagram showing the calculation of dimensions for a fluorinated ethylene propylene-based coaxial cable given desired characteristics.

FIG. 4 is a diagram showing the calculation of dimensions for a fluorinated ethylene propylene-based coaxial cable given desired characteristics.

FIG. 5 is a diagram showing the calculation of dimensions for a polyethylene-based coaxial cable given desired characteristics.

FIG. 6 is a diagram showing the calculation of dimensions for a polyethylene-based coaxial cable given desired characteristics.

FIG. 7 is a diagram showing the calculation of dimensions for a silicone-based coaxial cable given desired characteristics.

FIG. 8 is a diagram showing the calculation of dimensions for a silicone-based coaxial cable given desired characteristics.

FIG. 9 is a flowchart of a method 900 of manufacturing a high voltage standoff coaxial cable, according to embodiments of the present invention.

FIG. 10 shows a block diagram of an example computer system 100 usable with system and methods according to embodiments of the present invention.

### DETAILED DESCRIPTION

The systems and methods described can be used in the design of coaxial cables with high standoff voltage capacity for a given impedance and greater flexibility than standard coaxial cables. In some embodiments, this may entail first setting the requirements for an insulator of the coaxial cable based at least in part on a desired standoff voltage capacity, which then drives the dimensions of the other components of the coaxial cable while retaining the desired features of the coaxial cable for high-voltage applications.

### I. Coaxial Cable Characteristics

As previously mentioned, standard coaxial cables are often designed for relatively high impedances with low-voltage applications in mind. Typically when designing a standard coaxial cable, a desired impedance is selected first as a primary constraint in order to ensure that the cable provides low signal attenuation and has a matching impedance with other components of the coaxial system being used with the cable. Formulas exist for calculating the impedance of a standard coaxial cable, as well as for deriving the dimensions of components of the cable for maintaining that desired impedance. Thus, the selection of a desired impedance as a primary constraint can be used to drive the design choices of a standard coaxial cable by using those formulas.

The standard formulas for calculating a coaxial cable impedance include:

Z₀=(138 log(D_{L}/D_{S}))/(√E_{R}). Formula 1

I_{T}=(D_{L}−D_{S})/2 Formula 2

D_{R}=D_{L}/D_{S}=10^{Z}₀√E_{R}/¹³⁸. Formula 3

D_{S}=2I_{T}/(D_{R}−1). Formula 4

I_{T}=FₒS(V_{ST}/I_{DS}). Formula 5

Where Z₀ is the impedance, D_{L} is the outer diameter of insulator, and approximates inner diameter of outer conductor, D_{S} is the inner diameter of insulator, and approximates outer diameter of inner conductor, D_{R} is the insulator diameter ratio, equal to D_{L}/D_{S}, E_{R} is the material dielectric constant, I_{T} is the insulation thickness, FoS is the factor of safety, V_{ST} is the voltage standoff, and I_{DS} is the insulation dielectric strength.

As previously mentioned however, this impedance-driven approach is not well-suited for high voltage applications. For example, using the standard formulas to calculate the dimensions of a coaxial cable having a high impedance of 20 ohms can result in a cable which has a large diameter, is likely to be very stiff, and has too low a voltage capacity for high-voltage applications.

High-voltage applications may instead require a coaxial cable having high standoff voltage, which is the dielectric strength or the breakdown voltage of the insulator. In other words, the insulator must have a high enough dielectric strength in order to withstand the greater electric field produced by the high voltage without breaking down or experiencing failure of its insulating properties. Thus, in some embodiments, it may be desirable to use an insulator-driven approach by first selecting the properties and requirements for the cable insulator (based at least in part on a desired standoff voltage capacity) and using the insulator dimensions to drive the dimensions of the other components of the coaxial cable. In some of such embodiments, it may also be desirable for the dimensions of the components to be selected in order to match system impedance while providing minimal cable cross section for better cable flexibility.

The components of a typical coaxial cable often include an inner conductor (such as a strand of wire) surrounded by an insulator, which is surrounded by an outer conductor and a jacket. In some embodiments, a high-voltage coaxial cable may be similar in many respects, with the inner conductor of the high-voltage coaxial cable being solid and/or formed of a unitary material.

In other embodiments, the inner conductor of the high-voltage coaxial cable may be hollow or defined by an inner cavity. This space may be filled with vacuum, or a “filler” of any substance comprising one or more gases (including air), one or more liquids, and/or one or more solids. This can include dispersed media or substances such as foam, in which pockets of gas are trapped within a liquid or solid. Any suitable materials may be used in filling the space. It should be noted that the remainder of this disclosure refer to an embodiment in which the space within the inner conductor contains a filler, which is illustrated as a solid in the figures. The embodiment is an example selected for purposes of clarity and facilitating understanding and is intended to be non-limiting.

A hollow inner conductor may provide various advantages for high-voltage coaxial cables. In some embodiments, the desired characteristics of the coaxial cable may dictate a certain ratio between the diameters of the outer conductor and inner conductor. For example, the sizing of the diameter of the outer conductor and the diameter of the inner conductor may play a significant role in controlling the impedance of the cable or the various aspects of the impedance (ie., inductance, capacitance, and resistance). Larger diameter cables also tend to have less leakage. In order to preserve that ratio in some cases, the diameter of the inner conductor may need to be relatively large. However, a solid inner conductor having a large diameter may make the cable inflexible. A hollow inner conductor can add flexibility to the cable, while also reducing the cost, weight, and amount of material needed for the inner conductor. Signal transmission may be largely unaffected by the use of a hollow inner conductor; the phenomenon known as the skin effect results in a tendency for alternating current to flow mostly near the outer surface of the inner conductor, which becomes more apparent as the frequency increases.

In some embodiments, a filler within the hollow inner conductor can be used in addition to the hollow inner conductor. In some embodiments, a filler may provide structural support to the cable and prevent the inner conductor from kinking or caving in, which can result in signal losses or even dielectric breakdown of the surrounding insulator in high-voltage applications. In some embodiments, a filler may be used to prevent moisture from entering the hollow inner conductor. In some embodiments, a filler may be used for manufacturing purposes. For example, the inner conductor may be formed around the filler such that the filler takes on a similar role to a mold in order to keep the walls of the inner conductor of a certain uniform thickness. This may simplify the manufacturing process or make it easier to produce cables within desired tolerances.

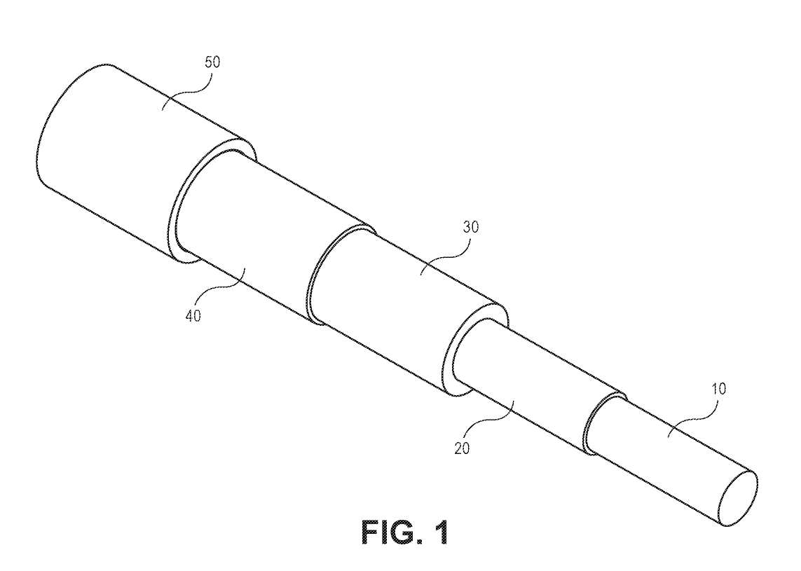

Referring now to the figures, FIG. 1 is diagram of a manufactured coaxial cable according to embodiments of the present invention. For purposes of convenience, the terms “braid” and “conductor” are used synonymously and interchangeably in this disclosure. The conductors of the contemplated coaxial cable need not be braided and may have any structure suitable for use in a coaxial cable. A coaxial cable can contain at least a filler 10, an inner braid or conductor 20, an insulator 30, and outer braid or conductor 40, and a jacket 50. The inner braid 20 can surround the filler 10. The insulator 30 can surround the inner braid 20. The thickness of the insulator is determined from at least a desired high voltage standoff, a safety factor, and a dielectric constant of the chosen insulator material.

The insulator has an outer diameter and inner diameter. Varying combinations of the outer diameter and the inner diameter of the insulator may be chosen for a desired thickness of the insulator. For example, an insulator having a thickness of 10 mm can have an outer radius of 100 mm and an inner radius of 90 mm, or it can have an outer radius of 15 mm and an inner radius of 5 mm. Either configuration would provide the same insulator thickness, and thus the same dielectric strength. However, the outer diameter and the inner diameter of the insulator would change the insulator diameter ratio, which is defined as the ratio of the outer diameter of the insulator to the inner diameter of the insulator. The insulator diameter ratio of the outer to inner diameters can vary over a range of values. In certain aspects, for example, the insulator diameter ratio of the coaxial cable may be between 1 and 100. Various values for the insulator diameter ratio of the coaxial cable are possible, and the preceding examples are not meant to be limiting. It should be noted that the insulator diameter ratio is closely related to the ratio of the diameters of the outer and inner conductor. In some embodiments, nearly equal radii of the inner and outer conductors (and thus, an insulator diameter ratio closer to 1) may minimize inductance. In such a scenario, if the thickness of the insulator needed for the desired standoff voltage is relatively large, the radii of the inner and outer conductors may also need to be large in order to fit the insulator while preserving the desired cable characteristics.

An outer braid 40 can surround the insulator. A jacket 50 can surround the outer braid 40. The dimensions of the inner and outer braids are determined by at least the dimensions of the insulator, and the dimensions of the inner braid determine the dimensions of the filler 10. In some embodiments, the filler diameter can be determined based on the inverse of the insulator diameter ratio. Thus, the dimensions of the filler may be dependent on the dimensions of the inner braid, which is dependent on the insulator thickness and the insulator diameter ratio, which are determined based on the desired characteristics of the cable—including the desired standoff voltage, the selected safety factor, and the dielectric constant of the chosen insulator material.

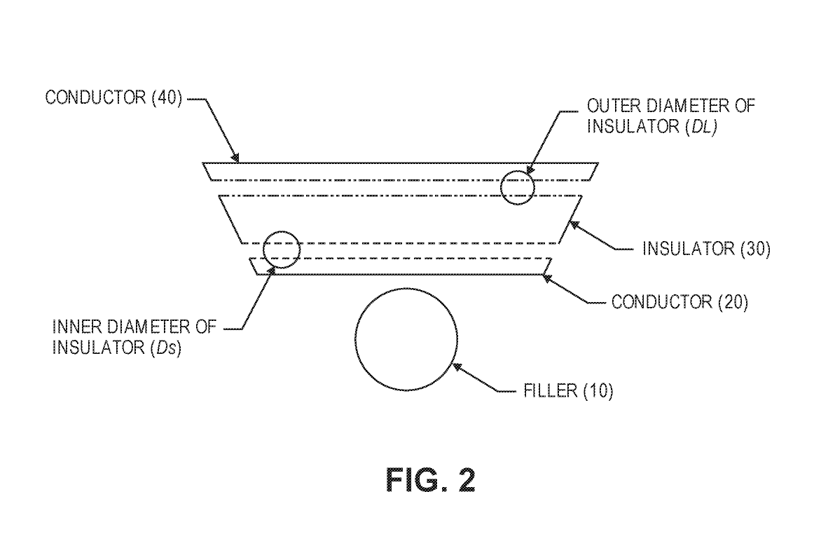

FIG. 2 is diagram of an unrolled cross-section of manufactured coaxial cable without a jacket according to embodiments of the present invention. A coaxial cable can contain a filler 10, an inner braid or conductor 20, an insulator 30, and an outer conductor 40. The dimensions of the insulator 30 can be used to drive the dimensions of the rest of the components of the coaxial cable. The system described herein may have an insulator 30 that is much thicker than that of a traditional coaxial cable in order to provide a cable with high standoff voltage capacity for a given impedance and greater flexibility than standard coaxial cable.

The inner and outer braids can comprise various materials and compositions. In certain aspects, for example, the inner and outer braids may comprise solid conductors. Similarly, in certain aspects, the filler material may comprise various materials. For example, the filler may comprise a plastic. That plastic can be composed in various ways, for example the plastic of the filler can be solid or foam-based.

Often, the insulator diameter ratio (and thus, the distance between the outer conductor and inner conductor), as well as the dielectric strength of the insulator, are the major influence on the impedance,. This can be seen by Formula 1 above, which states that the characteristic impedance, Z₀=(138 log(D_{L}/D_{S}))/(√E_{R}). Since the braiding used for conductors in a coaxial cable only produces a very small difference in distance measurements, this standard formula can still be used despite being intended for solid conductors. It should be noted that a given impedance can be determined based on varying combinations of the insulator diameter ratio and the dielectric strength of the insulator, E_{R}. For various plastics E_{R} can often range from 1.5 to 4.0, though E_{R} may be lower or higher depending on the material. The jacket thickness may not influence the impedance. The jacket thickness and material can vary to meet other design requirements. The filler within the inner conductor may not influence the impedance. As such, the filler can be designed using one or more materials as needed to meet design requirements.

In some embodiments, there may be a specific insulator material already in mind. This information can be used, along with the desired standoff voltage and factor of safety, in order to determine the insulator thickness and insulator diameter ratio needed in order to achieve a specific impedance. This information can also be used to determine the dimensions of the inner conductor and the outer conductor, as well as other components of the coaxial cable. This insulator-driven process is described in further detail below.

### II. Coaxial Cable Property Determination Process

In order to provide a coaxial cable with a high standoff voltage capacity, greater flexibility than standard coaxial cable, and a given impedance, the dimensions of the insulator may be determined first. This determination could drive the dimensions of all of the other elements of the coaxial cable.

The insulator is depicted as element 30 in both FIG. 1 and FIG. 2. Various materials are contemplated for the insulator. Some of the materials contemplated include but are not limited to: FEP (Teflon), polytetrafluoroethylene (PTFE), Kapton plastic (polyamide), polyethylene (PE) and silicon.

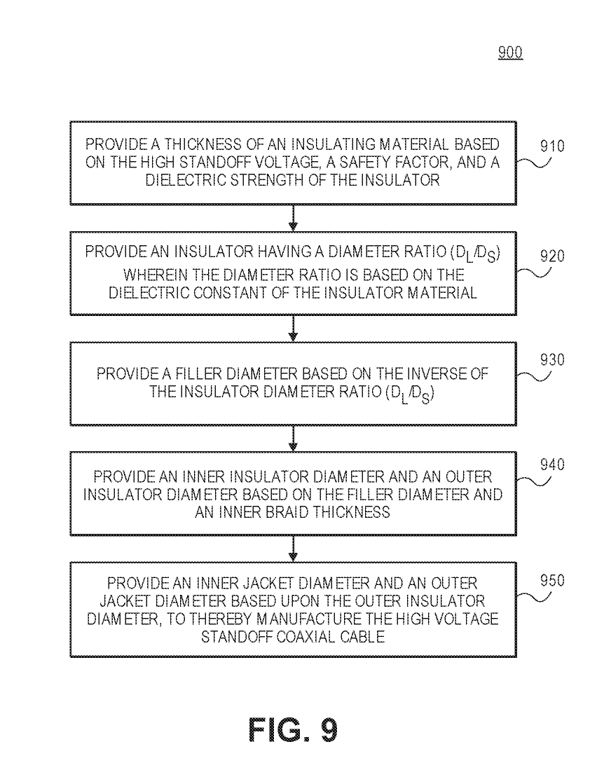

FIG. 9 is a flowchart of a method 900 of designing a high voltage standoff coaxial cable, according to embodiments of the present invention. FIG. 9 shows an iterative process for determining the dimensions of a high voltage standoff coaxial cable. Once the insulation material desired is determined along with a desired standoff voltage, and a safety factor, the rest of the required pieces of data can be calculated. The chosen insulation material can have several intrinsic properties, for example a dielectric constant. In certain aspects, the dielectric constant can be any of a range of values, for example for particular materials it may range from 1.9 to 3.5. Various other values for the dielectric constant are possible.

At step 910, a thickness of an insulating material (I_{T}) is calculated based on the high standoff voltage, a safety factor, and a dielectric strength of the insulator. As shown in Formula 5, the thickness of the insulating material may be determined by multiplying the standoff voltage by the safety factor, and dividing by the dielectric strength of the insulator. The safety factor may be set according to design needs, but generally it will be at least 2, in order to provide additional safety. The standoff voltage is a desired value, and the dielectric strength of the insulator may be determined by the manufacturer of the insulator. However, the insulator diameter ratio is needed as well in addition to the insulator thickness in order to determine the dimensions of the remaining components of the cable.

At step 920, a diameter ratio (D_{L}/D_{S}) and cable impedance are provided, wherein the diameter ratio is based on the dielectric constant of the insulator material and desired cable impedance. The insulator diameter ratio may be calculated using Formula 3 listed above. In some embodiments, the desired cable impedance will be chosen for purposes of impedance matching.

At step 930, a filler diameter based on the inverse of the insulator diameter ratio (D_{L}/D_{S}) may be provided. The filler diameter may be calculated by multiplying I_{T} by 2 and dividing by the diameter ratio minus 1. The filler diameter is the diameter of item 10 in FIG. 1 and FIG. 2. The filler diameter may also be considered as being dependent on the inner braid diameter, which is in turn dependent on the inner insulator diameter, which is in turn dependent on the insulator diameter ratio and the insulator thickness, and so forth. Accordingly, the filler diameter is dependent on the initial constraints selected for driving the design choices of the cable—the desired high voltage standoff, the safety factor, the dielectric strength of the insulator, and the desired impedance.

At step 940, an inner insulator diameter and an outer insulator diameter based on the filler diameter and an inner braid thickness may be provided. The inner insulator diameter may be determined by adding twice the braid thickness times to the filler diameter. The outer insulator diameter may be determined by adding two times the insulation thickness to the inner insulator diameter.

At step 950, an inner jacket diameter and an outer jacket diameter based upon the outer insulator diameter may be provided, to thereby manufacture the high voltage standoff coaxial cable. The inner jacket diameter may be determined by adding the braid thickness to the outer insulator diameter. The jacket safety factor may differ from that used to calculate the insulator dimensions. The outer jacket diameter may be determined calculated to meet different design requirements. Thus, it can be seen that this insulator-driven approach to determining the dimensions of the various cable components takes into account desired high voltage standoff, the safety factor, and the dielectric strength of the insulator in addition to the desired impedance. Once all of the necessary dimensions of the cable are determined, the cable may be manufactured and will result in having those desired characteristics. In order to manufacture the cable, the filler may be surrounded with an inner conductor having a diameter. The filler may have a diameter that is dependent on the initial constraints selected for driving the design choices of the cable—the desired high voltage standoff, the safety factor, the dielectric strength of the insulator, and the desired impedance. The filler diameter may also be related to the diameter of the inner conductor, and both may be determined based on the dimensions of the insulator which depend on the desired cable characteristics and selected initial constraints. The inner conductor may then be surrounded by the insulator, which has an outer diameter, an inner diameter, and a thickness based on a desired impedance, desired high voltage standoff, safety factor, and the dielectric strength of the insulator. Various types of materials and configurations are contemplated for the insulator. In circumstances where the insulator is flowable (e.g., gaseuous, liquid, liquid that solidifies, and so forth) or vacuum, the inner conductor may by surrounded by spacers and/or the outer conductor before the vacuum is created or the flowable insulator is added. For example, the inner conductor may be surrounded by the outer conductor by spacers or supports before the liquid or gas insulator is added to the space between the inner conductor and the outer conductor. However, in some embodiments the insulator is a solid. After the inner conductor is surrounded by the insulator, the insulator may be surrounded by the outer conductor having a diameter that is related to the outer insulator diameter. Additional layers of material may be further added to surround the outer conductor, including a jacket. The jacket may have an inner and outer diameter and the inner diameter of the jacket may be related to the outer diameter of the outer conductor underneath the jacket.

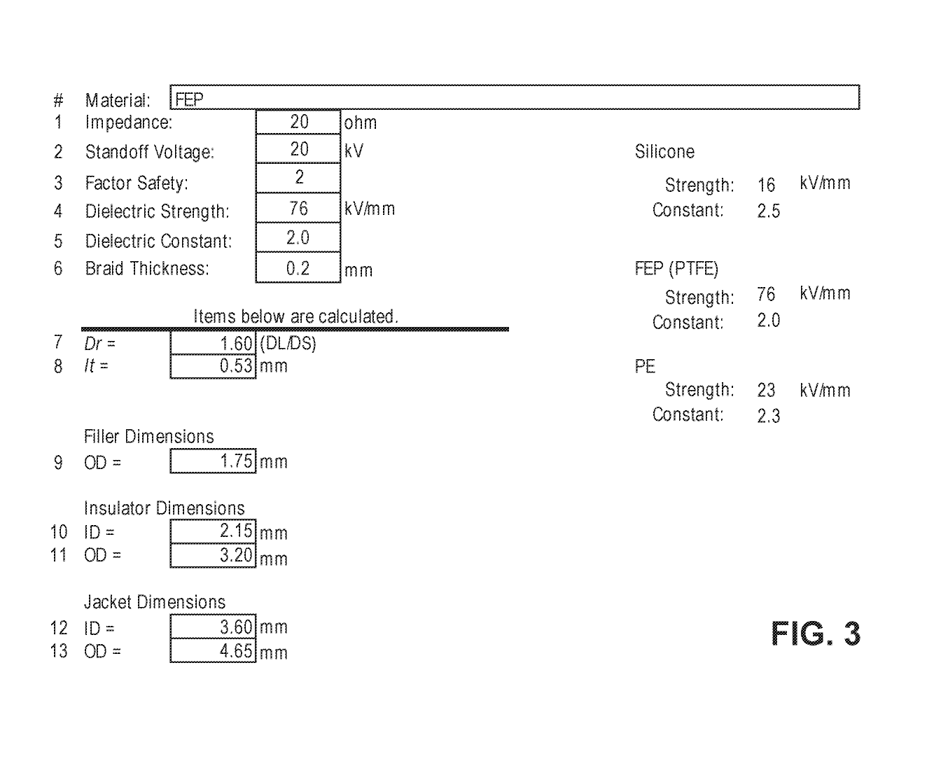

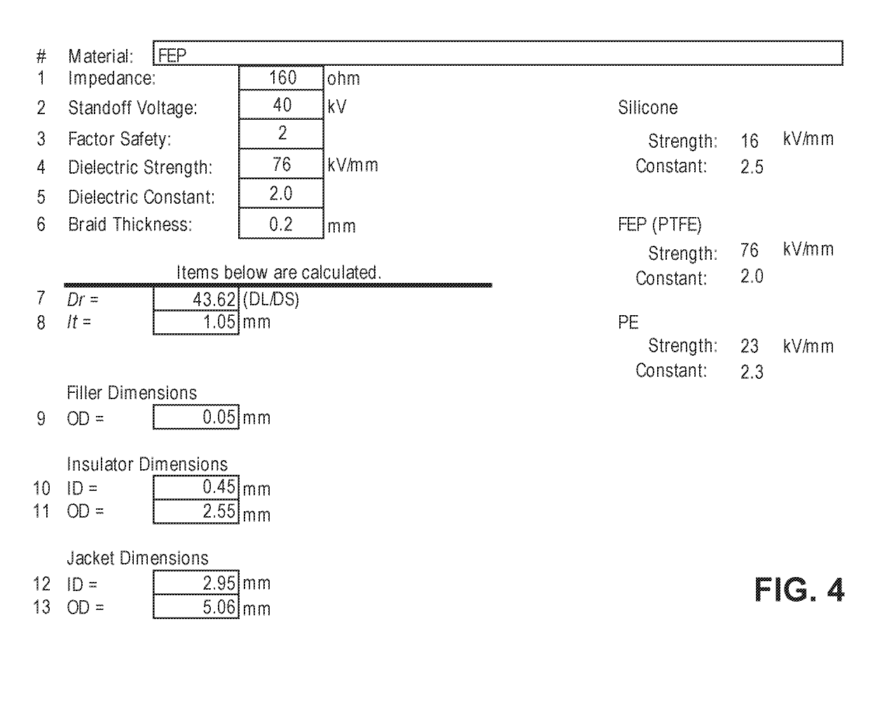

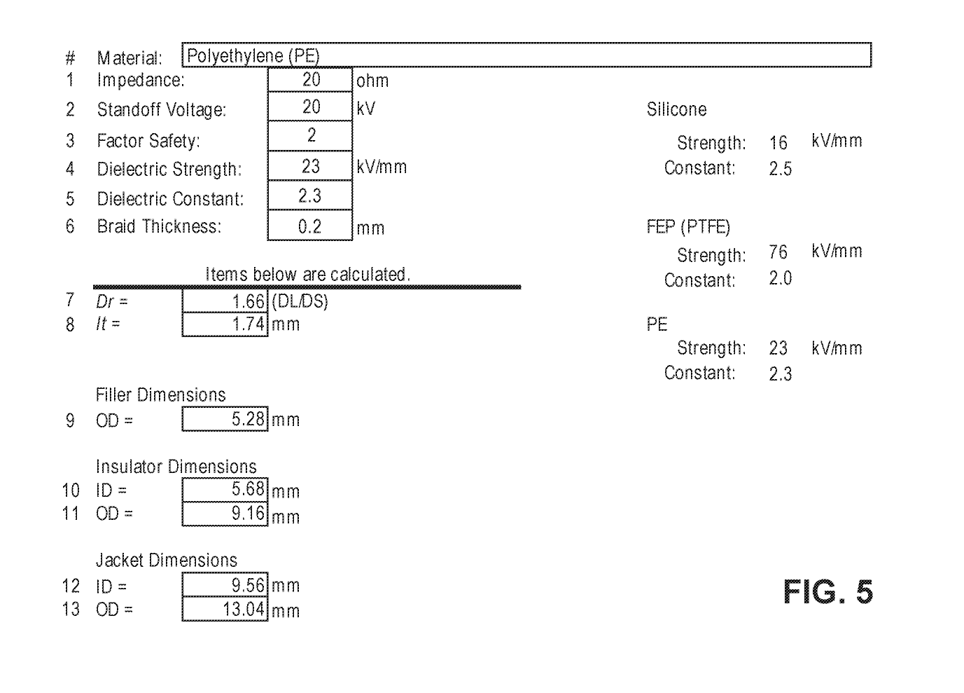

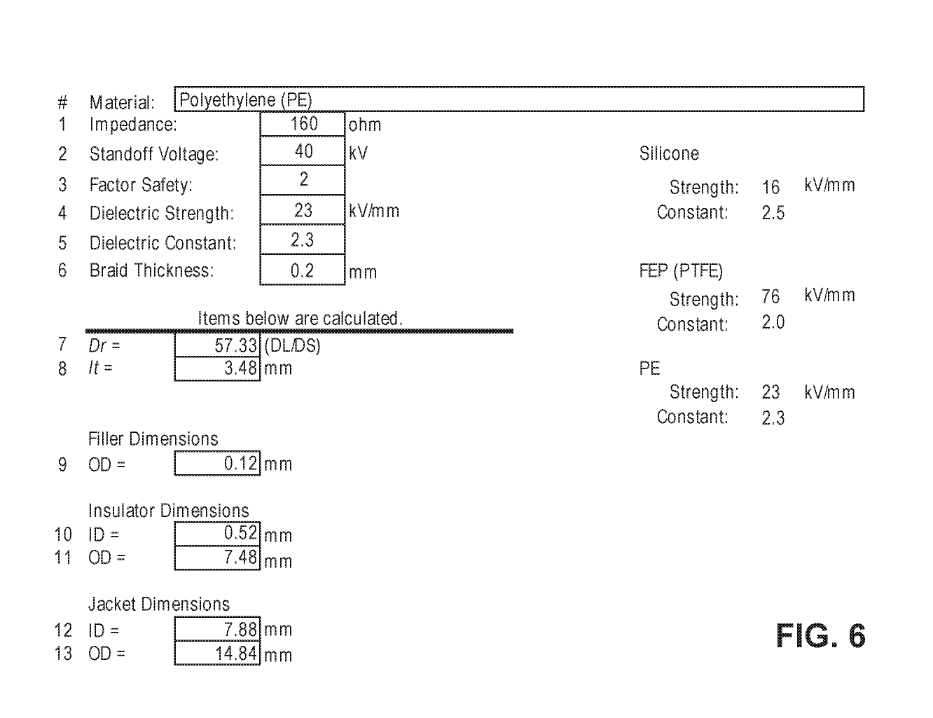

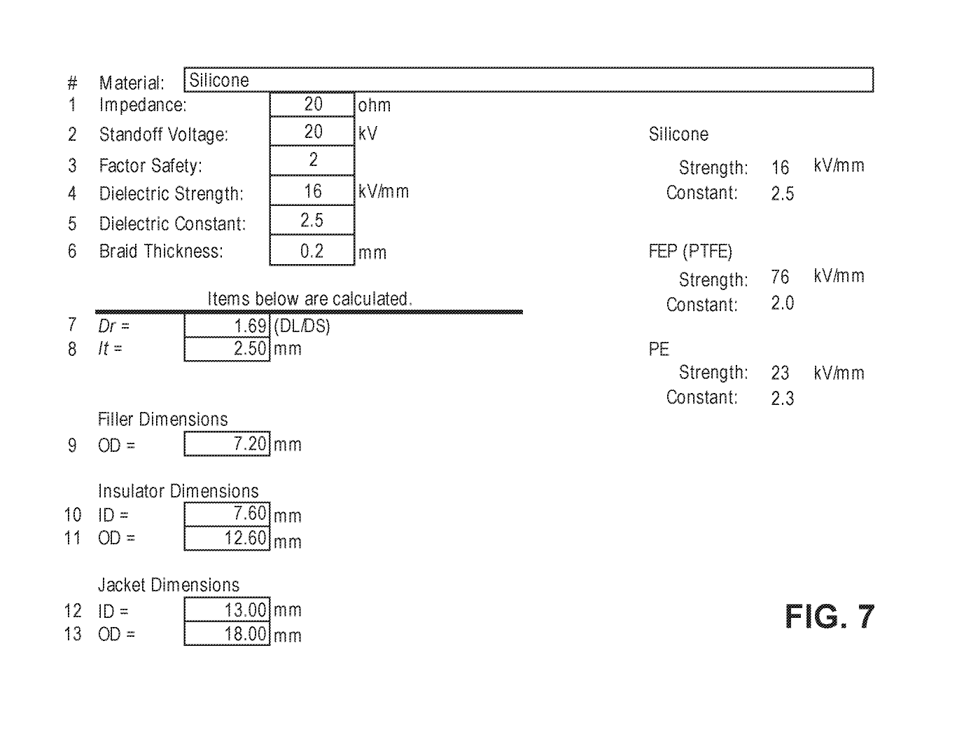

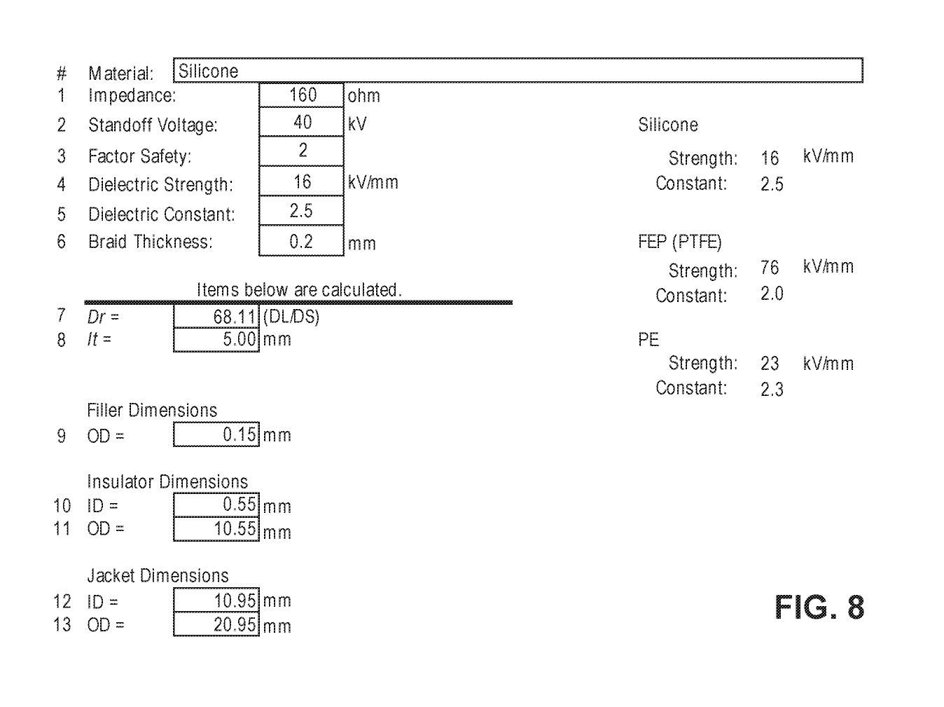

FIGS. 3-8 show the calculated dimensions for various coaxial cables given an impedance, a standoff voltage, a safety factor, a dielectric strength, a dielectric constant and a braid thickness. Using the process described herein and in the flowchart of FIG. 9, for example in FIG. 3, the dimensions for a high voltage FEP coaxial cable may be determined, where there is an impedance of 20 ohm, a standoff voltage of 20 kV, a safety factor of 2, a dielectric strength of 76 kV/mm, a dielectric constant of 2, and braid thickness of 0.2.

FIG. 3, for example shows the calculated dimensions for a coaxial cable given a coaxial cable where items 7 through 13 are the calculated dimensions of the cable using the data provided. The thickness of an insulating material (I_{T}) is calculated using the high standoff voltage times the safety factor, divided by the dielectric strength of the insulator. A diameter ratio D_{R}=D_{L}/D_{S} is calculated, wherein using Formula 3 listed above. The filler diameter, shown as item 9 (OD) may be calculated by multiplying I_{T} by 2 and dividing by the diameter ratio minus 1. The inner insulator (or spacer) dimension, item 10, may be calculated by adding the braid thickness times the safety factor to the filler diameter. The outer insulator (or spacer) diameter, item 11 diameter may be determined by adding twice the insulation thickness to the inner insulator diameter. The inner jacket, item 12, diameter may be determined by adding the braid thickness times the safety factor to the outer insulator diameter. The outer jacket diameter, item 13, may be determined by adding two times the jacket thickness to the inner jacket diameter.

The coaxial cable can have various properties. For example, the coaxial cable can have an impedance. In certain aspects, the impedance of the coaxial cable can vary over a range of values. For example, the impedance of the coaxial cable may be between 10 and 500 ohms, or 15 and 50 ohms. Various values for the impedance of the coaxial cable are possible, and the preceding examples are not meant to be limiting.

The coaxial cable can also have a high voltage standoff. The high voltage standoff of the coaxial cable can vary over a range of values. For example, the high voltage standoff of the coaxial cable may be between 10 and 500 kilovolts, or 20 and 100 kilovolts. Various values for the impedance of the coaxial cable are possible, and the preceding examples are not meant to be limiting.

### III. Computer System

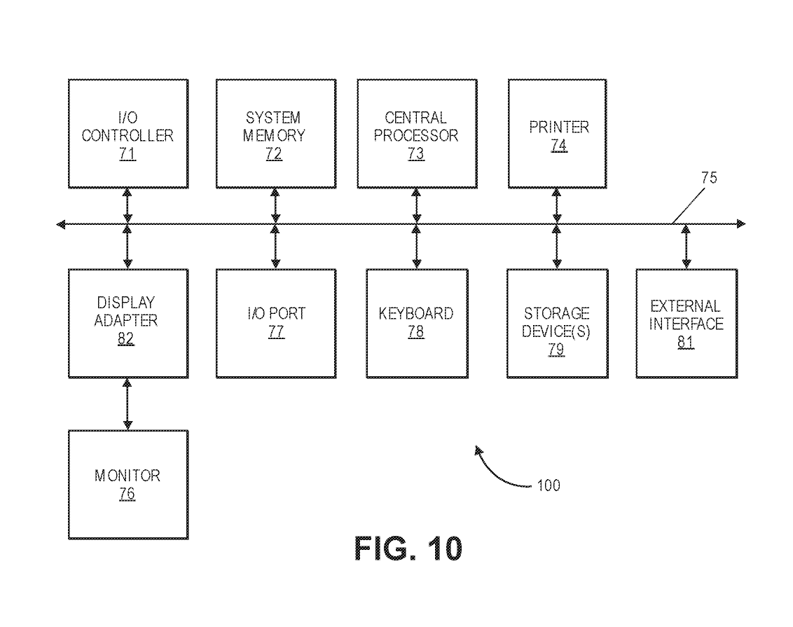

Any of the computer systems mentioned herein may utilize any suitable number of subsystems. Examples of such subsystems are shown in FIG. 10 in computer apparatus 100. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 10 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 100 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned herein are incorporated by reference in their entirety for all purposes. None is admitted to be prior art.

What is claimed is:

1. A high voltage standoff coaxial cable, the coaxial cable comprising:
a filler;
an inner conductor surrounding the filler, the inner conductor having a diameter;
an insulator surrounding the inner conductor, the insulator having a dielectric strength and having:
an outer insulator diameter;
an inner insulator diameter; and
a thickness chosen based on a desired high voltage standoff, a safety factor, and the dielectric strength of the insulator,
wherein the outer insulator diameter and the inner insulator diameter are chosen based on a desired impedance and the chosen insulator thickness;
an outer conductor surrounding the insulator, the outer conductor having a diameter based on the outer insulator diameter; and
a jacket surrounding the outer conductor,
wherein the inner conductor diameter is based on the inner insulator diameter, and
wherein the filler has a diameter dependent on the desired high voltage standoff, the safety factor, the dielectric strength of the insulator, and the desired impedance.

2. The coaxial cable of claim 1, wherein the inner conductor and the outer conductor comprise solid conductors.

3. The coaxial cable of claim 1, wherein the filler comprises a plastic.

4. The coaxial cable of claim 3, wherein the plastic is solid.

5. The coaxial cable of claim 3, wherein the plastic is foam-based.

6. The coaxial cable of claim 1, wherein the desired impedance of the coaxial cable is between 10 ohms and 500 ohms.

7. The coaxial cable of claim 6, wherein the desired impedance of the coaxial cable is between 15 ohms and 50 ohms.

8. The coaxial cable of claim 1, wherein the cable has an actual high voltage standoff that is between 10 kilovolts and 500 kilovolts.

9. The coaxial cable of claim 8, wherein the actual high voltage standoff of the coaxial cable is between 20 kilovolts and 100 kilovolts.

10. The coaxial cable of claim 1, wherein an actual impedance of the coaxial cable is inversely proportional to a dielectric constant of the insulator.

11. The coaxial cable of claim 1, wherein a ratio of the outer insulator diameter to the inner insulator diameter (D_{L}/D_{S}) is between 1.00 to 100.00.

12. The coaxial cable of claim 1, wherein the insulator comprises a material having a dielectric constant (E_{R}) of between 1.9 and 3.5.

13. The coaxial cable of claim 1, wherein the insulator comprises a material which is a member selected from the group consisting of silicone, polytetrafluoroethylene (PTFE), polyethylene (PE), Kapton plastic (polyamide), and fluorinated ethylene propylene (FEP).

14. A method for manufacturing a high voltage standoff coaxial cable, the method comprising:
surrounding a filler with an inner conductor, the inner conductor having a diameter;
surrounding the inner conductor with an insulator, the insulator having a dielectric strength and having:
an outer insulator diameter;
an inner insulator diameter; and
a thickness chosen based on a desired high voltage standoff, a safety factor, and the dielectric strength of the insulator,
wherein the outer insulator diameter and the inner insulator diameter are chosen based on a desired impedance and the chosen insulator thickness; and
surrounding the insulator with an outer conductor, the outer conductor having a diameter based on the outer insulator diameter,
wherein the inner conductor diameter is based on the inner insulator diameter, and
wherein the filler has a diameter dependent on the desired high voltage standoff, the safety factor, the dielectric strength of the insulator, and the desired impedance.

15. The method of claim 14, wherein the insulator comprises an insulator diameter ratio between the outer insulator diameter and the inner insulator diameter, wherein the insulator diameter ratio is dependent on the dielectric strength of the insulator and the desired impedance.

16. The method of claim 15, wherein the filler diameter is dependent on an inverse of the insulator diameter ratio.

17. The method of claim 14, wherein the inner conductor has a thickness, and wherein both the inner insulator diameter and the outer insulator diameter are dependent on the filler diameter and the inner conductor thickness.

18. The method of claim 14, wherein method further comprises surrounding the outer conductor with a jacket having an inner jacket diameter and an outer jacket diameter, wherein the inner jacket diameter and the outer jacket diameter are both dependent on the outer insulator diameter.

19. The method of claim 14, wherein the inner conductor and the outer conductor comprise solid conductors.

20. The method of claim 14, wherein the filler comprises a plastic.
